(19) United States
(12) Patent Application Publication
(10) Pub. No.: US 2020/0203786 A1
(43) Pub. Date: Jun. 25, 2020

(54) ACCUMULATOR ARRANGEMENT

(71) Applicant: Mahle International GmbH, Stuttgart (DE)

(72) Inventors: Akash Athanikar, In Rawadi Pen Raigad Maharashtra (IN); Torsten Frank, Vaterstetten (DE); Martin Mittermaier, Muenchen (DE); Erik Person, Stuttgart (DE); Dieter Reisinger, Vaihingen/Enz (DE)

(21) Appl. No.: 16/719,573

(22) Filed: Dec. 18, 2019

(30) Foreign Application Priority Data
Dec. 19, 2018 (DE) 102018222279.7

(51) Int. Cl. H01M 10/625; H01M 2/10; H01M 10/613; H01M 10/6557; H01M 10/6568; H01M 10/6552

(52) U.S. Cl. CPC H01M 10/625; H01M 2/1077; H01M 10/613; H01M 2220/20; H01M 10/6568; H01M 10/6552; H01M 10/6557

(57) ABSTRACT

An accumulator arrangement may include a plurality of battery cells respectively having a plurality of bearing surfaces. The plurality of battery cells may be stacked in a stacking direction to form at least one battery block. The arrangement may further include at least one cooling device that may include a plurality of cooling elements through which a cooling fluid is flowable. A respective cooling element may be arranged between and abut against adjacent battery cells and clamped thereto. The at least one cooling device may further include at least one fluid guide tube having at least one fluid guide duct through which the cooling fluid is flowable. The at least one fluid guide tube may include at least one deformable adaptation area that may, via deformation, compensate at least one of an expansion and a compression of the at least one battery block in the stacking direction.

### CROSS-REFERENCE TO RELATED APPLICATIONS

This application claims priority to German Patent Application No. DE 10 2018 222 279.7, filed on Dec. 19, 2018, the contents of which are hereby incorporated by reference in their entirety.

### TECHNICAL FIELD

The invention relates to an accumulator arrangement for a hybrid or electric vehicle.

### BACKGROUND

Accumulator arrangements for hybrid or electric vehicles are already known from the prior art and have a plurality of battery cells, which are combined to form a plurality of battery blocks. The battery cells are usually clamped together in the respective battery blocks. If the battery cells are embodied, for example, as pouch cells, they have to additionally be supported by suitable components or holders in the battery block. The pouch cells can thus for example be placed in a form-fitting manner into auxiliary frames made of plastic. The auxiliary frames comprising the pouch cells can then be stacked against one another, and the pouch cells can be held in the battery block in this way. Cooling ducts for cooling the pouch cells can additionally be formed in the auxiliary frames. However, the auxiliary frames usually only assume a holding function, and the cooling occurs by means of cooling structures, to which cell conductors of the pouch cells are thermally attached. Apart from the auxiliary frames, U-shaped cooling plates, which discharge the heat generated in the pouch cells to a plate, through which a coolant flows, are alternatively clamped thereto between the pouch cells. If the battery cells are embodied as prismatic cells, for example, elastic spacer elements need to be arranged between them.

Due to the fact that the battery cells can expand as a result of the charging state or the aging of the battery cells, unwanted tensions can be built up in the battery block in the case of the conventional solutions. According to today's prior art, a direct cooling of the battery cells can additionally not take place. Due to the expansion of the battery cells, tolerance and sealing problems can furthermore arise.

### SUMMARY

It is thus the object of the invention to specify an improved or at least alternative embodiment for an accumulator arrangement of the generic type, in the case of which the described disadvantages are overcome. In particular the cooling of the battery cells is to be optimized in the accumulator arrangement.

This object is solved according to the invention by means of the subject matter of the independent claim(s). Advantageous embodiments are the subject matter of the dependent claim(s).

An accumulator arrangement is provided for a hybrid or electric vehicle and has a plurality of battery cells comprising bearing surfaces located opposite one another. The battery cells are thereby in particular prismatic cells. Facing one another with the bearing surfaces, the battery cells are stacked against one another in the stacking direction to form at least one battery block. The accumulator arrangement has a cooling device comprising a plurality of cooling elements, through which a cooling fluid can flow, wherein the respective cooling element is arranged between the adjacent battery cells and is clamped to the latter in the battery block. The respective cooling element thereby abuts against the bearing surfaces of the respective adjacent battery cells so as to transfer heat. The cooling device further has at least one fluid guide tube comprising at least one fluid guide duct, wherein the cooling fluid from the at least one fluid guide duct can be supplied into the respective cooling element or from the respective cooling element into the at least one fluid guide duct. According to the invention, the at least one fluid guide tube has at least one deformable adaption area, which, due to its deformation, compensates an expansion or a compression of the battery block in the stacking direction in the at least one fluid guide tube.

In the accumulator arrangement according to the invention, the battery cells can be cooled directly via the cooling elements, through which the cooling fluid can flow. The respective cooling elements are thereby fluidically connected to the at least one fluid guide tube, so that the cooling fluid can be supplied to the respective cooling elements and can be discharged from the respective cooling elements. The fluid guide tube can be compressed or expanded in the stacking direction by means of the at least one adaptation area, so that the deformation of the battery cells, which is created as a result of the charging state or of the aging of the battery cells, is compensated in the stacking direction in response to the production as well as during operation of the battery block. Tensions at the connection points between the respective cooling elements and the fluid guide tube are thus in particular avoided, so that the risk of a leakage in the battery block is minimized. The fluid guide tube can be formed, for example, from elastomeric or thermoplastic plastic and as a blow molded part or an injection molded part or an extrusion.

It can advantageously be provided that the cooling device has the first fluid guide tube comprising the first fluid guide duct and the second fluid guide tube comprising the second fluid guide duct. It can alternatively be provided that the fluid guide tube has the first fluid guide duct and the second fluid guide duct. Independently of the design of the cooling device described here, the first fluid guide duct then corresponds to a fluid distribution duct for distributing the cooling fluid into the respective cooling elements, and the second fluid guide duct corresponds to a fluid collecting duct for collecting the cooling fluid from the respective cooling elements.

It can advantageously be provided that the at least one adaptation area in the at least one fluid guide tube is formed by a wall, which is folded in a bellows-like manner, of the at least one fluid guide tube. The wall, which is folded in a bellows-like manner, provides for an expansion or a compression of the at least one fluid guide tube in the stacking direction, whereby the deformation of the battery cells, which is created as a result of the charging state or the aging of the battery cells is compensated in the stacking direction in response to the production as well as during operation of the battery block. The at least one adaptation area in the at least one fluid guide tube can alternatively be formed from an elastically deformable plastic.

To fluidically connect the at least one guide tube to the respective cooling elements, it can be provided that the respective cooling element has at least one first fluid connection, and the at least one fluid guide tube has at least one second fluid connection for the respective cooling element. The respective first fluid connections can then be secured to the respective second fluid connections in a form-fitting manner and/or in a material-bonded manner and/or in a force-fitting manner so as to be fluid-tight to the outside and so that the cooling fluid can flow through. An adhesive connection or a welded connection or a plug connection, for example, are thus conceivable. The welded connection can thereby be established, for example, by means of infrared welding or by means of heating element welding. To the securing of the at least one fluid connection to the at least one second fluid connection, the two fluid connections can each be aligned transversely to the stacking direction. Advantageously, a clip holder for the force-fitted receiving of the at least one fluid guide tube comprising the corresponding at least one second fluid connection can additionally be formed on the respective cooling element around the at least one first fluid connection.

In the case of a further development of the accumulator arrangement according to the invention, it is provided that the at least one fluid guide tube consists of a plurality of tube segments, which are assigned to the respective cooling elements and through which the cooling fluid can flow, each comprising an adaptation area. The respective tube segments are thereby secured to one another in a form-fitting manner and/or in a material-bonded manner and/or in a force-fitting manner to form the at least one fluid guide tube. The respective tube segments can thus be secured to one another in a form-fitting manner, for example by means of a spring-groove connection, and can engage with one another in the stacking direction. Alternatively or additionally, the respective tube segments can be fastened to one another by means of an adhesive connection or a welded connection. The welded connection can thereby be established, for example, by means of infrared welding. Alternatively or additionally, a screw connection is also conceivable, preferably comprising a seal for securing the respective tube segments to one another. The tube segments can be produced as blow molded parts or as injection molded parts of an elastomeric or thermoplastic plastic.

The respective tube segment can advantageously comprise the at least one second fluid connection for the at least one first fluid connection in the cooling element. The respective tube segment is then assigned to the respective cooling element and is fluidically connected thereto. The respective tube segment can be secured to the respective cooling element, for example in a form-fitting manner and/or in a material-bonded manner and/or in a force-fitting manner so as to be fluid-tight to the outside and so that the cooling fluid can flow through. For example, an adhesive connection or a welded connection or a plug connection are thus conceivable. The welded connection can thereby be established, for example, by means of infrared welding. The respective tube segment can alternatively be formed integrally on the respective cooling element, so that the cooling element and the respective tube segment form a one-piece unit.

As already described above, the adaptation area in the respective tube segment of the at least one fluid guide tube can thereby be formed by a wall, which is folded in a bellows-like manner, of the at least one fluid guide tube. If the respective adaptation area of the at least one fluid guide tube in the respective tube segment is alternatively formed from an elastically deformable plastic, the respective adaptation area can be produced by an injection molding of a preferably elastomeric plastic to a base body of a preferably thermoplastic plastic. For example the at least one second fluid connection can then be formed in the adaptation area, whereby the respective first fluid connections at the second fluid connections can be sealed to the outside.

In the case of a further development of the cooling device, it is provided that the respective tube segment has a connecting part and at least one intermediate part. The respective tube segment is then fluidically connected to the respective cooling element via the connecting part, and the adaptation area is formed in the at least one intermediate part. To fluidically connect the connecting part to the cooling element, the at least one second fluid connection is formed in the connecting part of the tube segment. The intermediate part and the connecting part can be secured to one another in a form-fitting manner and/or in a material-bonded manner and/or in a force-fitting manner to form the respective tube segment. For example an adhesive connection or a welded connection or a groove-spring connection or a screw connection are thus conceivable. The welded connection can preferably be established by means of infrared welding. The connecting part and/or the intermediate part can be formed, for example, as a blow molded part or an injection molded part or as an extrusion.

The respective connecting part can be secured to the respective cooling element for example in a form-fitting manner and/or in a material-bonded manner and/or in a force-fitting manner so as to be fluid-tight to the outside and so that the cooling fluid can flow through. For example, an adhesive connection or a welded connection or a plug connection are thus conceivable. The welded connection can thereby be established, for example, by means of infrared welding. The respective connecting part can alternatively be formed on the cooling element. The adaptation area in the intermediate part can thereby be formed by a wall, which is folded in a bellows-like manner, of the intermediate part. The intermediate part can alternatively have the adaptation area of an elastically deformable plastic. The intermediate part can alternative consist or be completely formed from an elastically deformable plastic, respectively, and can thus depict the adaptation area of the at least one fluid guide tube in its entirety.

In the case of an alternative further development of the accumulator arrangement according to the invention, it is provided that the at least one fluid guide tube consists of a plurality of tube segments, which are assigned to the respective cooling elements and through which the cooling fluid can flow. Contrary to the above-described alternative, the tube segments are then secured to one another so as to be displaceable in the stacking direction to the at least one fluid guide tube. An adaptation area is thus in each case formed between the respective adjacent tube segments. By means of a displacement of the individual tube segments in the stacking relative to one another, an expansion or a compression of the battery block in the stacking direction can advantageously be compensated in the at least one fluid guide tube.

The respective tube segment can advantageously comprise the at least one second fluid connection for the at least one first fluid connection in the cooling element. The respective tube segment is then assigned to the respective cooling element and is fluidically connected thereto. The respective tube segment can be secured to the respective cooling element for example in a form-fitting manner and/or in a material-bonded manner and/or in a force-fitting manner so as to be fluid-tight to the outside and so that the cooling fluid can flow through. For example, an adhesive connection or a welded connection or a plug connection are thus conceivable. The welded connection can thereby be established, for example, by means of infrared welding. The respective tube segment can alternatively be formed integrally on the respective cooling element, so that the cooling element and the respective tube segment form a one-piece unit.

In the case of a further development of the accumulator arrangement according to the invention, it is provided that the respective cooling element is formed by a frame and separating foils secured to the frame on both sides. With the frame, the separating foils thereby limit a cooling interior, through which the cooling fluid can flow, and abut on the bearing surfaces of the respective adjacent battery cells so as to transfer heat. The at least one fluid guide duct of the at least one fluid guide tube is thereby fluidically connected to the cooling interior of the cooling element through the frame. For this purpose, the at least one first fluid connection is advantageously formed in the frame. The at least one first fluid connection is preferably aligned in the frame transversely to the stacking direction and leads out of the cooling interior to the outside transversely to the stacking direction to the at least one fluid guide tube. The first fluid connection can thus be secured directly to the at least one second fluid connection in the at least one fluid guide tube or in the respective tube segment or in the respective connecting part. The separating foils are elastically deformable or flexible, respectively, and remain attached to the bearing surfaces of the battery cells due to the pressure built up by the cooling fluid in the cooling interior even in response to an expansion or a compression of the battery cells as a result of the charging state or the aging. The cooling of the battery cells can thus advantageously be optimized.

The frame of the respective cooling element can be made, for example, of a thermoplastic or also of an elastomeric plastic in an injection molding process or can also be metallic. The separating foils can be made of a plastic and can be adhered to the frame, can be welded to the frame preferably ultrasonically welded or can also be pressed into the frame, preferably with an additional seal. The respective separating foil can thus have a plastic layer or a plurality of plastic layers. The plurality of plastic layers can thereby consist of identical plastic or of different plastics. The respective separating foil can additionally also have a metal layer, which is preferably made of aluminum. The metal layer can be vapor-deposited onto one of the plastic layers or can be applied in a different way. To be able to guide the cooling fluid in the cooling interior, a fluid guide structure can be arranged in the cooling interior of the respective cooling element. The cooling guide structure can thereby be formed integrally on the frame of the cooling element or by means of the joined areas of the two separating foils.

In summary, the fluid guide tube in the accumulator arrangement according to the invention can be compressed or expanded in the stacking direction by means of the at least one adaptation are, so that the deformation of the battery cells, which is created as a result of the charging state or of the aging of the battery cells, can be compensated in the stacking direction in response to the production as well as during operation of the battery block. Tensions at the connection points between the respective cooling elements and the fluid guide tube can thus be avoided, and the risk of a leakage in the battery block can be minimized. The battery cells can further be cooled effectively, independently of the expansion or compression thereof, whereby the service life of the battery cells can be increased.

Further important features and advantages of the invention follow from the subclaims, from the drawings, and from the corresponding figure description on the basis of the drawings.

It goes without saying that the above-mentioned features and the features, which will be described below, cannot only be used in the respective specified combination, but also in other combinations or alone, without leaving the scope of the present invention.

Preferred exemplary embodiments of the invention are illustrated in the drawings and will be described in more detail in the following description, wherein identical reference numerals refer to identical or similar or functionally identical components.

### BRIEF DESCRIPTION OF THE DRAWINGS

In each case schematically,

FIG. 1 shows a partial view of an accumulator arrangement according to the invention comprising a cooling device in a first embodiment;

FIGS. 2 to 4 show views of individual parts of the cooling device in the first embodiment;

FIG. 5 shows a partial view of an accumulator arrangement according to the invention comprising a cooling device in a second embodiment;

FIGS. 6 and 7 show views of individual parts of the cooling device in the second embodiment;

FIGS. 8 to 12 show views of cooling devices, which are designed differently from one another, in a third embodiment;

FIG. 13 shows a view of a cooling device in a fourth embodiment;

FIGS. 14 to 17 show views of individual parts of the cooling device in the fourth embodiment;

FIGS. 18 to 22 show views of individual parts for a cooling device in a fifth embodiment.

### DETAILED DESCRIPTION

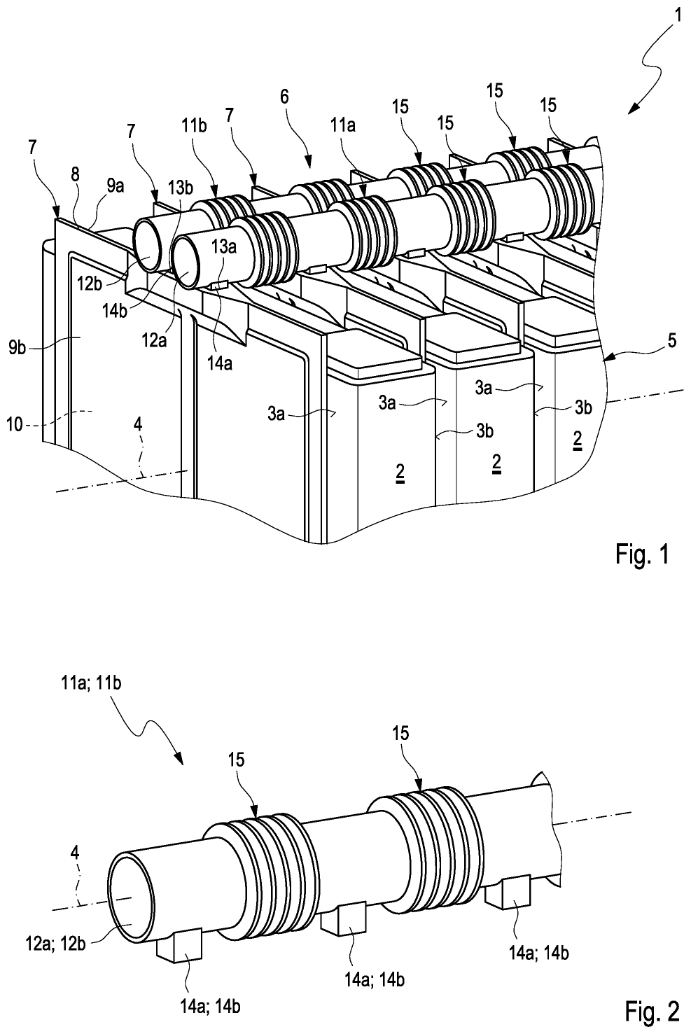

FIG. 1 shows a partial view of an accumulator arrangement 1 according to the invention for a hybrid or electric vehicle. The accumulator arrangement 1 has a plurality of battery cells 2 comprising bearing surfaces 3a and 3b located opposite one another. The battery cells 2, facing one another with the bearing surfaces 3a and 3b, are stacked to form a battery block 5 in the stacking direction 4. The accumulator arrangement 1 further has a cooling device 6, which has a plurality of cooling elements 7, through which a cooling fluid can flow. The respective cooling elements 7 thereby have a frame 8 and two separating foils 9a and 9b, which define a cooling interior 10. The respective cooling elements 7 are arranged between the battery cells 2 so as to be stacked therewith in the stacking direction 4, so that the separating foils 9a and 9b abut on the respective bearing surfaces 3a and 3b of the adjacent battery cells 2 so as to transfer heat. The separating foils 9a and 9b are flexible, so that the separating foils 9a and 9b remain attached to the bearing surfaces 3a and 3b even in response to an expansion or in response to a compression of the battery cells 2 as a result of the charging state or the aging, due to the pressure built up in the cooling interior 10 by means of the cooling fluid. The battery cells 2 can thus be effectively cooled in the accumulator arrangement 1 over the entire service life.

In the first embodiment, the cooling device 6 has two one-piece fluid guide tubes 11a and 11b, each comprising a fluid guide duct 12a and 12b. The fluid guide duct 12a can be, for example, a fluid distribution duct for distributing the cooling fluid, and the fluid guide duct 12b can be, for example, a fluid collecting duct for collecting the cooling fluid. The respective cooling elements 7 each have two first fluid connections 13a and 13b, and the respective fluid guide tubes 11a and 11b each have a second fluid connection 14a and 14b. The respective first fluid connections 13a and 13b are secured to the respective second connections 14a, 14b so as to be fluid-tight to the outside, so that the two fluid guide ducts 12a and 12b are fluidically connected to the cooling interior 10 of the respective cooling element 7. The respective first fluid connections 13a and 13b and the respective second connections 14a and 14b are thereby aligned transversely to the stacking direction 4, so that the respective fluid guide tube 11a and 11b can be secured directly to the respective cooling elements 7 without additional components. An adhesive connection or a welded connection between the respective fluid guide tubes 11a and 11b and the respective cooling elements 7 is conceivable thereby. The respective fluid guide tube 11a and 11b is formed in one piece and has a plurality of adaptation areas 15, which are distributed between the cooling elements 7. The adaptation areas 15 are formed between the respective second fluid connections 14a and 14b by means of a wall, which is folded in a bellows-like manner, of the respective fluid guide tube 11a and 11b. The respective adaptation areas 15 can compensate an expansion or a compression of the battery block 5 in the stacking direction 4, due to its deformation, in the respective fluid guide tube 11a and 11b. Connection points between the respective cooling element 7 and the respective fluid guide tune 11a and 11b can thus in particular be protected against additional tensions.

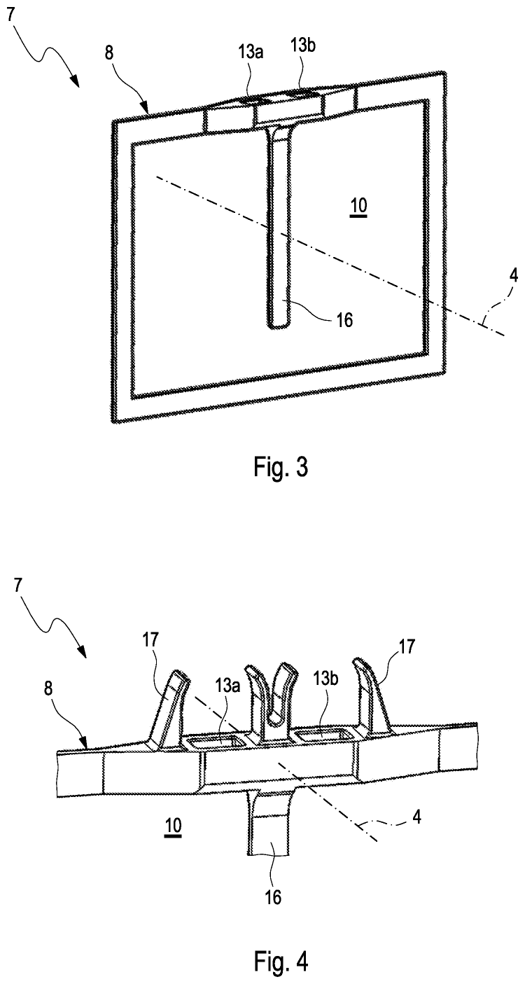

FIG. 2 shows an enlarged view of the respective fluid guide tune 11a or 11b in the cooling arrangement 6 in the first embodiment. FIG. 3 shows a view of the frame 8 of the cooling element 7 in the cooling arrangement 6 in the first embodiment. On the frame 8, a fluid guide structure 16 for guiding the cooling fluid through the cooling interior 10 is formed integrally or in one piece, respectively, with the frame 8 here. The fluid guide structure 16 divides the cooling interior 10 into two fluidically connected areas here, which are assigned to the respective first fluid connections 13a and 13b. FIG. 4 shows a view of the frame 8 comprising integrally formed chip holders 17 in the cooling arrangement 6 in the first embodiment. The fluid guide tubes 11a and 11b can be received in a force-fitting manner in the chip holders 17, in order to preserve connection points between the fluid guide tubes 11a and 11b and the respective cooling elements 7.

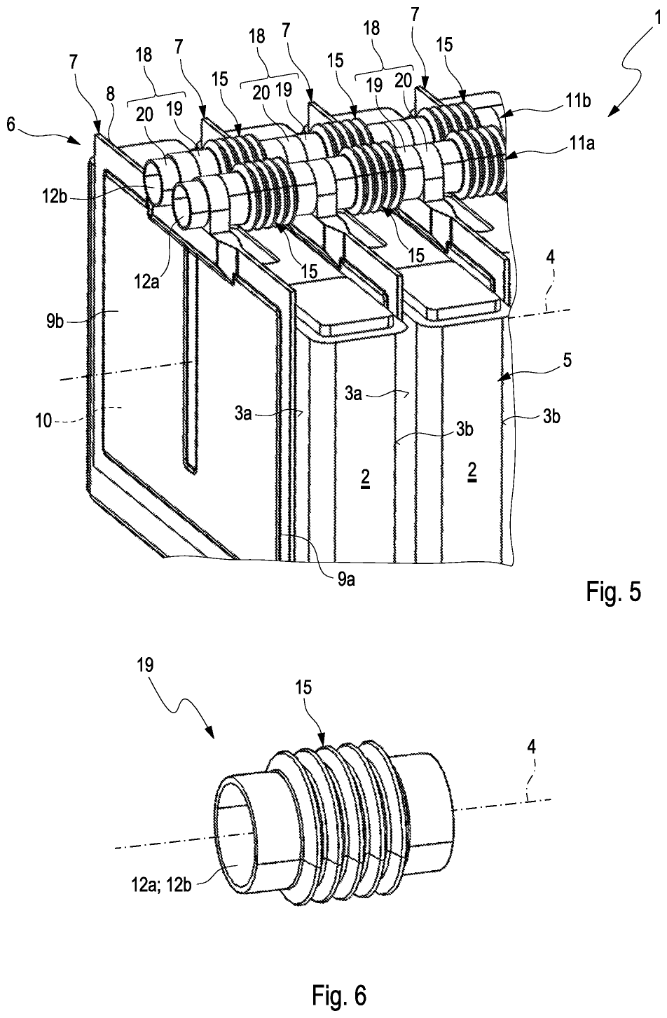

FIG. 5 shows a partial view of the accumulator arrangement 1 according to the invention comprising the cooling device 6 in a second embodiment. Contrary to the cooling device 6 in the first embodiment, the fluid guide tubes 11a and 11b are formed by means of a plurality of tube segments 18 here. The respective tube segments 18 are thereby in each case assigned to a cooling element 7 and have an intermediate part 19 and a connecting part 20. The connecting part 20 is formed integrally or in one piece, respectively, on the respective frame 8 of the cooling element 7 here, but can be secured thereto. On the respective intermediate part 19, the adaptation area 15 is formed by a wall, which is folded in a bellows-like manner, of the respective intermediate part 19. The respective intermediate part 19 and the respective connecting part 20 are secured to one another by means of a plug connection and can additionally also be secured to one another by means of an adhesive connection or a welded connection. The intermediate part 19 and the connecting part 20 can generally also connect integrally to one another to form the respective one-piece tube segment 18. The respective one-piece tube segments 18 can then be secured to one another or can connect integrally to one another to form the respective one-piece fluid guide tune 11a and 11b.

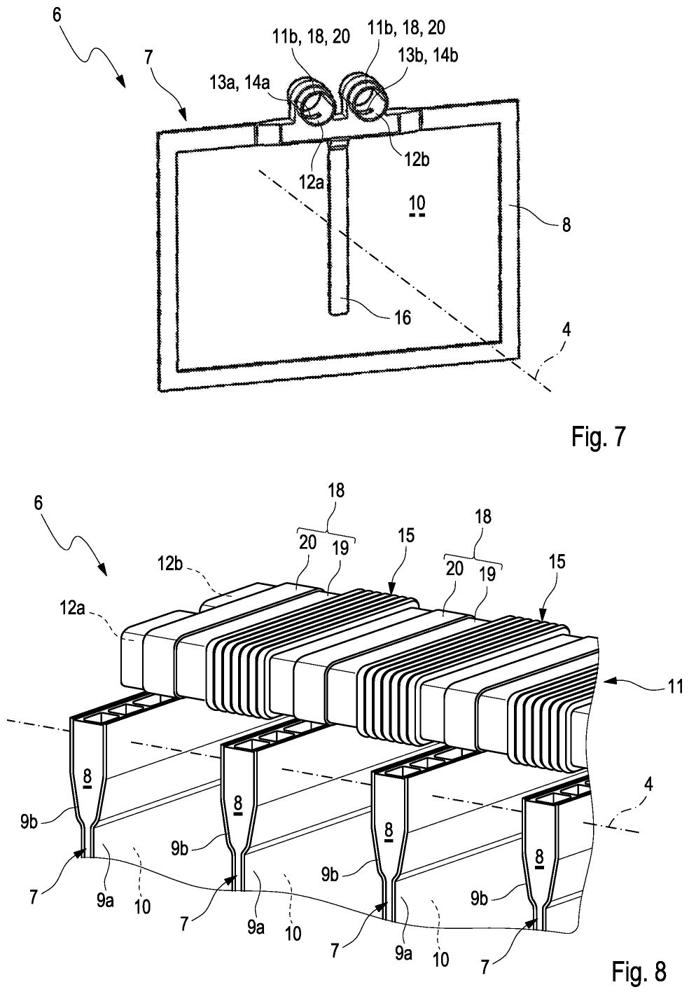

FIG. 6 shows a view of the intermediate part 19 comprising the adaptation area 15. FIG. 7 shows a view of the frame 8 comprising the respective connecting parts 20 of the cooling device 6. The fluid guide structure 16 is also formed on the frame 8 here.

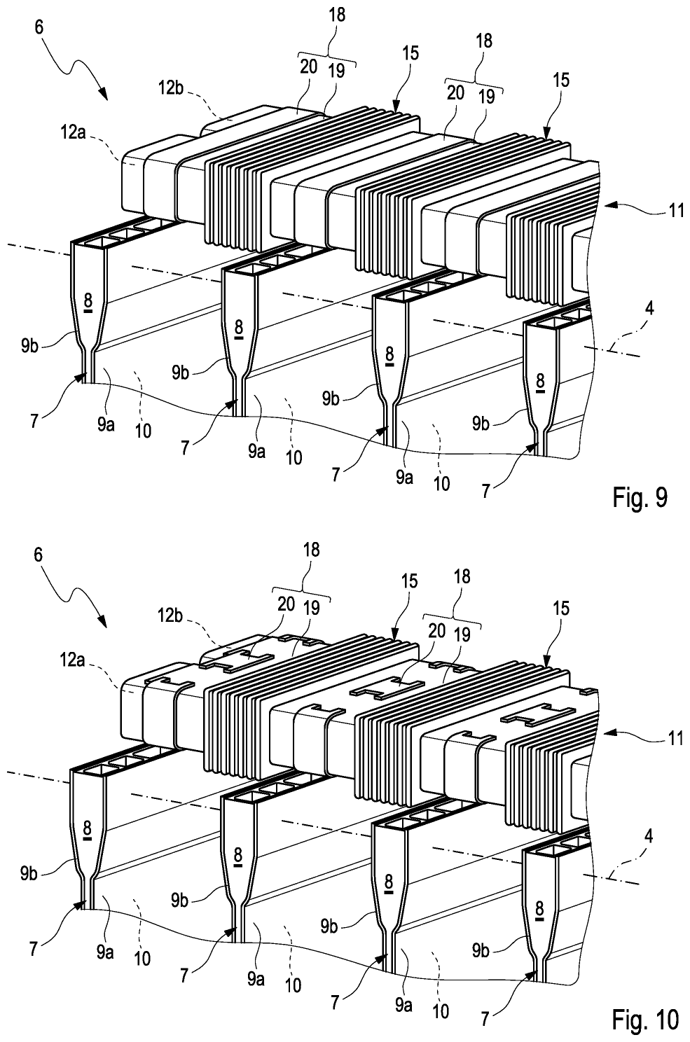

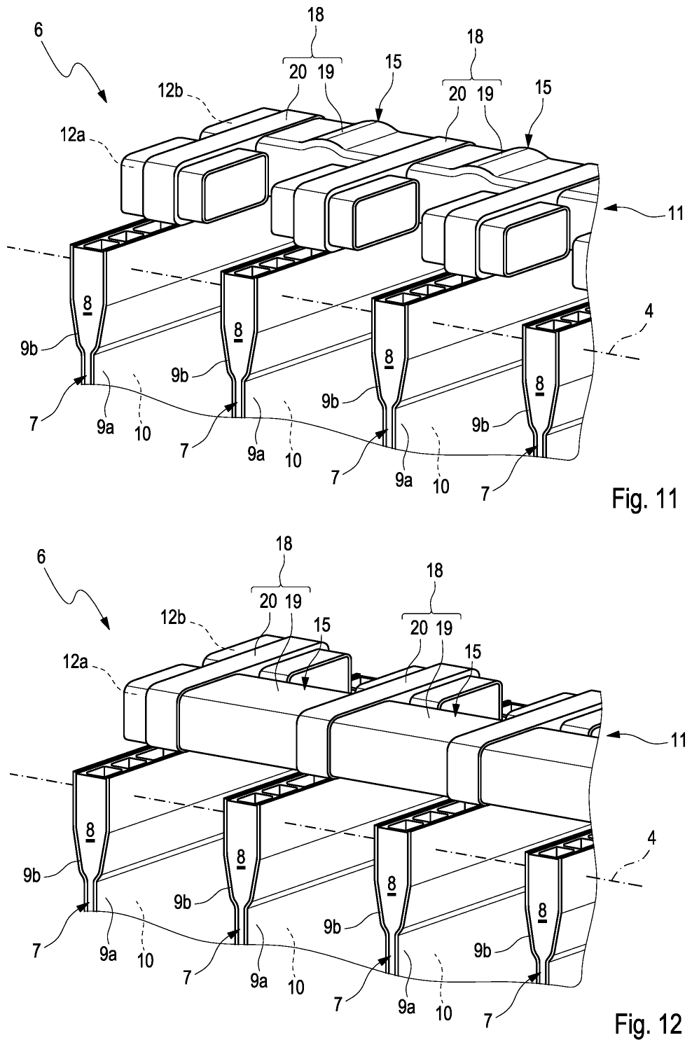

FIG. 8 to FIG. 12 show views of the cooling devices 6, which are designed differently, in a third embodiment. In the third embodiment, the cooling device has a single fluid guide tube 11, in which the two fluid guide ducts 12a and 12b are formed. The fluid guide tube 11 is formed from the plurality of tube segments 18 here, which are in each case formed from the intermediate part 19 and the connecting part 20. As in the cooling device 6 in the second embodiment, the respective adaptation area 15 of the fluid guide tube 11 is also formed on the respective intermediate elements 19. Views of the cooling devices 6 are shown in FIG. 8 to FIG. 10, in which an intermediate part 19 in each case corresponds to a connecting part 20. The respective intermediate part 19 further has the adaptation area 15, which is formed by a wall, which is folded in a bellows-like manner, of the respective intermediate part 19. The individual tube segments 18 of the cooling devices 6 in FIG. 8 to FIG. 10 thereby differ from one another in the design of the respective connecting parts 19. FIG. 11 and FIG. 12 show the cooling devices 6, in which two intermediate parts 19 are assigned to the respective connecting part 20. For the sake of clarity, however, only the intermediate parts 19 of the respective tube segments 18, which form the fluid guide duct 12a or 12b, are shown. The respective intermediate parts 19 are thereby formed from an elastically deformable plastic and thus completely form the respective adaptation area 15. The intermediate parts 19 in FIG. 11 and FIG. 12 differ from one another in their shape.

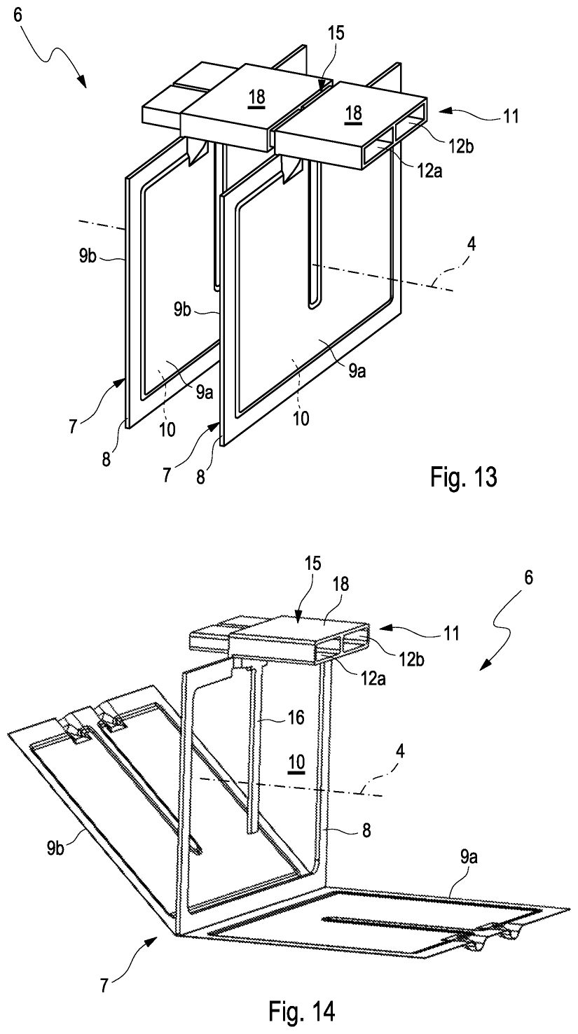

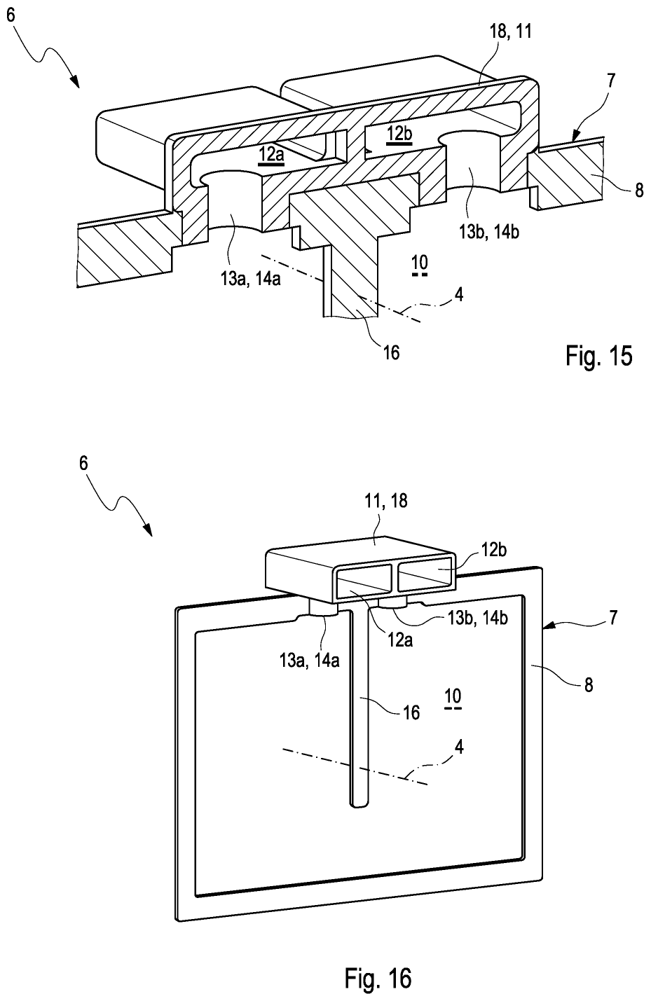

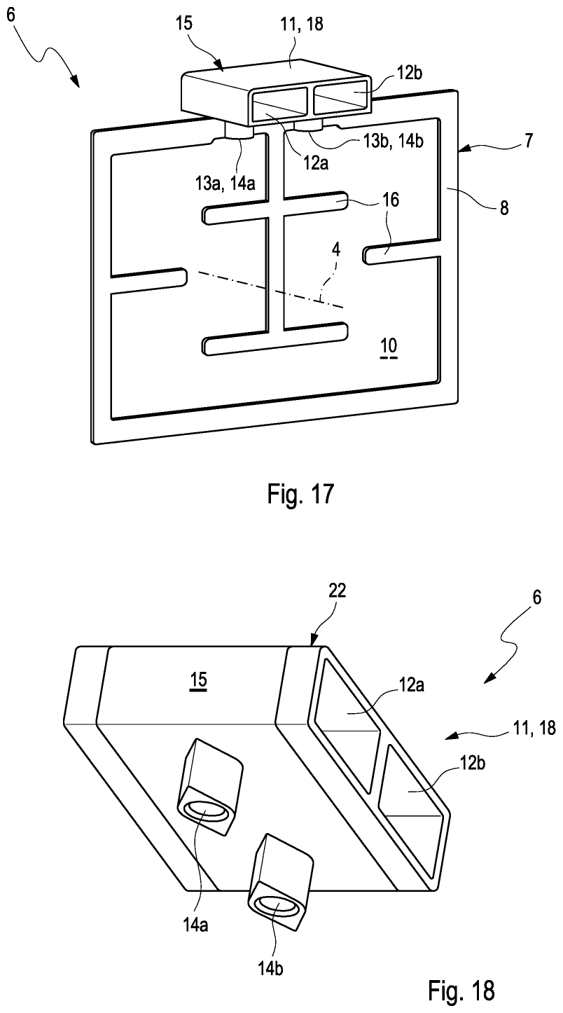

FIG. 13 shows a view of the cooling device 6 in a fourth embodiment. The cooling device 6 has the one-piece tube segments 18 here, which are formed integrally or in one piece, respectively, with the frame 8 of the respective cooling element 7 on the frame 8 of the respective cooling element 7. The respective tube segments 18 are secured to one another by means of a plug connection and thus form the multi-part fluid guide tube 11 comprising the two fluid guide ducts 12a and 12b. FIG. 14 shows a view of the cooling element 7 from FIG. 13 comprising the respective tube segment 18 in the cooling device 6 in the fourth embodiment. The two separating foils 9a and 9b, which are secured to the frame 8, are shown in an unfolded manner here. The fluid guide structure 16 is additionally formed on the frame 8. FIG. 15 shows a sectional view of the tube segment 18, which is formed integrally on the frame 8, in the cooling device 6 in the fourth embodiment. The first fluid connections 13a and 13b and the second fluid connections 14a and 14b are visible here, which are aligned transversely to the stacking direction 4 and which are fluidically connected to one another. FIG. 16 shows a view of the frame 8 comprising the tube segment 18 from FIG. 15 in the cooling device 6 in the fourth embodiment. A view of the frame 8 comprising the tube segment 18 from FIG. 15 and FIG. 16 is shown in FIG. 17, wherein the fluid guide structure 16, which is formed on the frame 8, has a different shape. The fluid guide structure 16 forms a meander-shaped flow path between the first fluid connections 13a and 13b here, so that the cooling fluid can be guided systematically through the cooling interior 10. In FIG. 13 to FIG. 17, the tube segments 18 can be secured to one another in a displaceable manner by means of a plug connection, so that the adaptation areas 15 of the respective fluid guide tune 11a re formed between the respective adjacent tube segments 18.

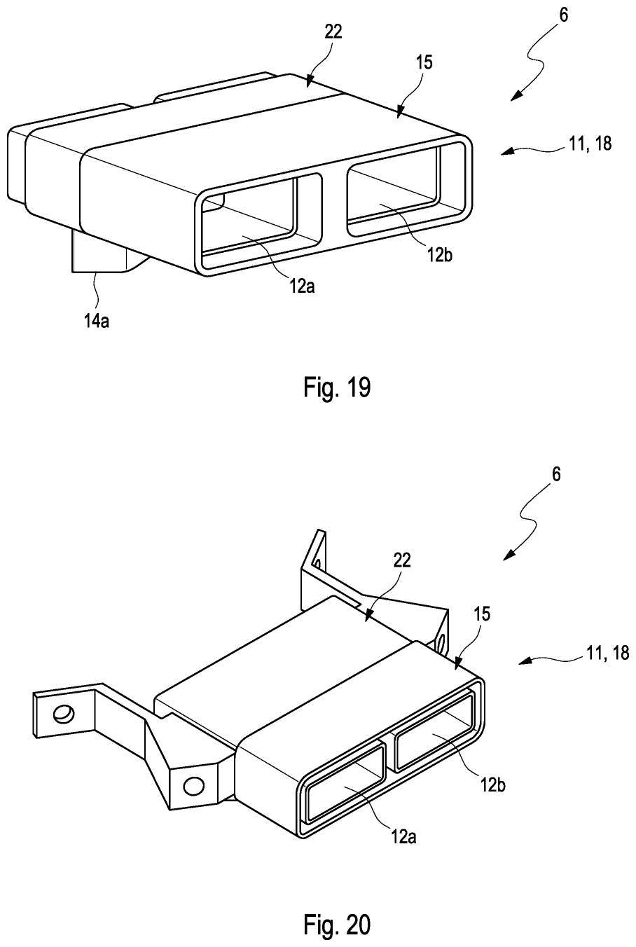

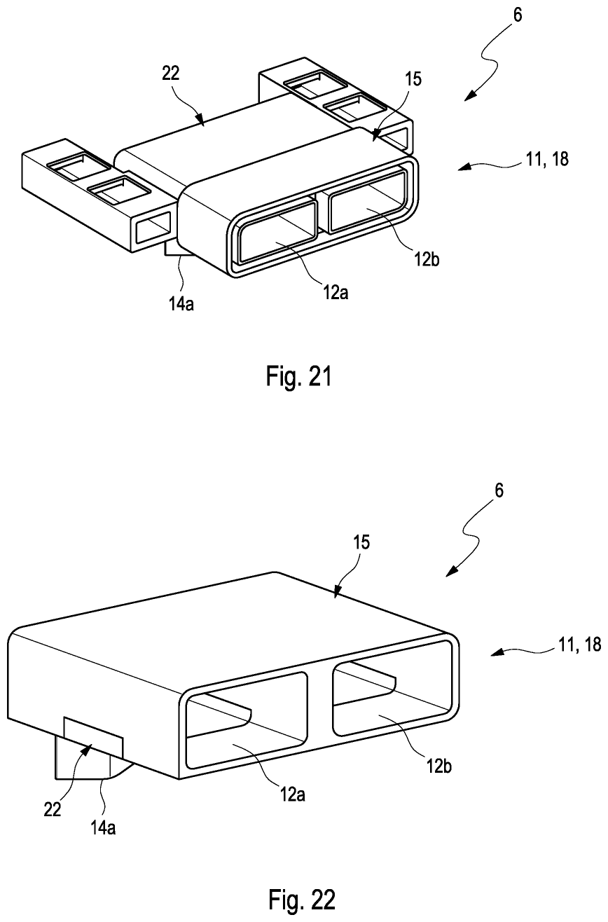

FIG. 18 to FIG. 22 show views of the tube segments 18 for the cooling device 6 in a fifth embodiment. In the fifth embodiment of the cooling device 6, the respective tube segment 18 in each case has the adaptation area 15 of an elastically deformable plastic, which is produced by means of an injection molding of an elastomeric plastic to a base body 22 of a preferably thermoplastic plastic. The tube segments in FIG. 18 to FIG. 22 differ in the shape of the base body 22 and of the respective adaptation area 15. The tube segments 18 according to FIG. 18 can further be secured to one another in a material-bonded manner; the tube segments 18 according to FIG. 19 by means of a plug connection and additionally in a material-bonded manner; the tube segments 18 according to FIG. 20 by means of a groove-spring connection and additionally in a force-fitting manner by means of a screw connection; the tube segments 18 according to FIG. 21 by means of a groove-spring connection and additionally in a material-bonded manner, and the tube segments 18 according to FIG. 22 in a material-bonded manner.

1. An accumulator arrangement for a hybrid or electric vehicle, comprising:
a plurality of battery cells respectively having a plurality of bearing surfaces disposed opposite one another;
the plurality of battery cells facing one another with the plurality of bearing surfaces and stacked in a stacking direction to form at least one battery block;
at least one cooling device including a plurality of cooling elements through which a cooling fluid is flowable for the at least one battery block;
the a respective cooling element of the plurality of cooling elements is arranged between adjacent battery cells of the plurality of battery cells and clamped thereto in the at least one battery block;
the respective cooling element abut ting against a bearing surfaces of each of the adjacent battery cells facilitating a transfer of heat;
the at least one cooling device further including at least one fluid guide tube having at least one fluid guide duct through which the cooling fluid is flowable at least one of into and out of the respective cooling element; and
wherein the at least one fluid guide tube is aligned in the stacking direction and includes at least one deformable adaptation area that, via deformation, compensates at least one of an expansion and a compression of the at least one battery block in the stacking direction in the at least one fluid guide tube.

2. The accumulator arrangement according to claim 1, wherein one of:
the at least one fluid guide tube includes a plurality of fluid guide tubes, the plurality of fluid guide tubes including a first fluid guide tube and a second fluid guide tube, the first fluid guide tube including a first fluid guide duct configured as a fluid distribution duct for distributing the cooling fluid into the respective cooling element, and the second fluid guide tube including a second fluid guide duct configured as a fluid collecting duct for collecting the cooling fluid from the respective cooling element; and
at least one fluid guide duct includes a plurality of fluid guide ducts, the plurality of fluid guide ducts including a first fluid guide duct and a second fluid guide duct, the first fluid guide duct configured as a fluid distribution duct for distributing the cooling fluid into the respective cooling element, and the second fluid guide duct configured as a fluid collecting duct for collecting the cooling fluid from the respective cooling element.

3. The accumulator arrangement according to claim 1, wherein at least one of:
the at least one adaptation area is defined by a wall, which is folded in a bellows-like manner, of the at least one fluid guide tube; and
the at least one adaptation area is composed of an elastically deformable plastic.

4. The accumulator arrangement according to claim 1, wherein:
the respective cooling element includes at least one first fluid connection, and the at least one fluid guide tube includes at least one second fluid connection for the respective cooling element; and
the at least one first fluid connection is secured to the at least one second fluid connection in at least one of a form-fitting manner, a material-bonded manner, and a force-fitting manner to be fluid-tight to an outside such that the cooling fluid is flowable therethrough.

5. The accumulator arrangement according to claim 4, further comprising a clip holder configured to receive the at least one fluid guide tube in a force-fitting manner, wherein the clip holder includes the at least one second fluid connection and is disposed on the respective cooling element around the at least one first fluid connection.

6. The accumulator arrangement according to claim 1, wherein:
the at least one adaptation area includes a plurality of adaptation areas;
the at least one fluid guide tube includes a plurality of tube segments assigned to the plurality of cooling elements and through which the cooling fluid is flowable, each of the plurality of tube segments including a respective adaptation area of the plurality of adaptation areas; and
the plurality of tube segments are secured to one another in at least one of a form-fitting manner, a material-bonded manner, and a force-fitting manner, and define the at least one fluid guide tube.

7. The accumulator arrangement according to claim 6, wherein the respective adaptation area each of the plurality of tube segments is composed of an elastically deformable plastic.

8. The accumulator arrangement according to claim 6, wherein:
each of the plurality of tube segments includes a connecting part and at least one intermediate part, each of the plurality of tube segments is fluidically connected to an associated cooling element of the plurality of cooling elements via the connecting part, and the respective adaptation area is disposed in the at least one intermediate part; and
the at least one intermediate part and the connecting part are secured to one another in at least one of a form-fitting manner, a material-bonded manner, and a force-fitting manner and define the respective tube segment.

9. The accumulator arrangement according to claim 1, wherein:
the at least one fluid guide tube includes a plurality of tube segments assigned to the plurality of cooling elements and through which the cooling fluid is flowable; and
the plurality of tube segments are secured to one another such that the plurality of tube segments are displaceable in the stacking direction to the at least one fluid guide tube, and the at least one adaptation area includes a plurality of adaptation areas that are each disposed between two adjacent tube segments of the plurality of tube segments.

10. The accumulator arrangement according to claim 6, wherein the plurality of tube segments are integrally arranged on the plurality of cooling elements.

11. The accumulator arrangement according to claim 1, wherein:
the respective cooling element is defined by a frame and a plurality of separating foils secured to the frame on both sides;
the frame and the plurality of separating foils delimit a cooling interior, through which the cooling fluid is flowable, and abut on the bearing surfaces of each of the adjacent battery cells to transfer heat; and
the at least one fluid guide duct is fluidically connected to the cooling interior via the frame.

12. The accumulator arrangement according to claim 11, wherein at least one of:
at least one of the plurality of separating foils includes at least one plastic layer; and
at least one of the plurality of separating foils includes at least one a plastic layer and at least one vapor-deposited metal layer.

13. The accumulator arrangement according to claim 11, further comprising a fluid guide structure structured and arranged within the cooling interior to guide the cooling fluid through the cooling interior, wherein the fluid guide structure is at least one of integrally arranged on the frame and defined by joined areas of the plurality of separating foils.

14. An accumulator arrangement for a hybrid or electric vehicle, comprising:
a plurality of battery cells respectively having a plurality of bearing surfaces disposed opposite one another;
the plurality of battery cells facing one another with the plurality of bearing surfaces and stacked in a stacking direction to form at least one battery block;
at least one cooling device including a plurality of cooling elements through which a cooling fluid is flowable for the at least one battery block;
a respective cooling element of the plurality of cooling elements is arranged between adjacent battery cells of the plurality of battery cells and clamped thereto in the at least one battery block;
the respective cooling element abutting against a bearing surface of each of the adjacent battery cells facilitating a transfer of heat;
the at least one cooling device further including at least one fluid guide tube having at least one fluid guide duct through which the cooling fluid is flowable at least one of into and out of the respective cooling element;
wherein the respective cooling element is defined by a frame and a plurality of separating foils coupled to the frame, the frame and the plurality of separating foils delimiting a cooling interior of the respective cooling element through which the cooling fluid is flowable; and
wherein the at least one fluid guide tube is aligned in the stacking direction and includes at least one deformable adaptation area that, via deformation, compensates at least one of an expansion and a compression of the at least one battery block in the stacking direction in the at least one fluid guide tube.

15. The accumulator arrangement according to claim 14, wherein:
the at least one fluid guide tube includes a plurality of fluid guide tubes;
the plurality of fluid guide tubes includes a first fluid guide tube and a second fluid guide tube;
the first fluid guide tube includes a first fluid guide duct configured as a fluid distribution duct for distributing the cooling fluid into the respective cooling element; and
the second fluid guide tube includes a second fluid guide duct configured as a fluid collecting duct for collecting the cooling fluid from the respective cooling element.

16. The accumulator arrangement according to claim 14, wherein:
the at least one fluid guide duct includes a plurality of fluid guide ducts;
the plurality of fluid guide ducts includes a first fluid guide duct and a second fluid guide duct;
the first fluid guide duct is configured as a fluid distribution duct for distributing the cooling fluid into the respective cooling element; and
the second fluid guide duct is configured as a fluid collecting duct for collecting the cooling fluid from the respective cooling element.

17. The accumulator arrangement according to claim 14, wherein the at least one adaptation area is defined by a wall, which is folded in a bellows-like manner, of the at least one fluid guide tube.

18. The accumulator arrangement according to claim 14, wherein at least one of the plurality of separating foils includes at least one plastic layer and at least one vapor-deposited metal layer.

19. The accumulator arrangement according to claim 18, wherein the at least one vapor-deposited metal layer is composed of aluminum.

20. The accumulator arrangement according to claim 14, wherein at least one of the plurality of separating foils includes a plurality of plastic layers composed of different plastics.
